(19) United States
(12) Patent Application Publication
(10) Pub. No.: US 2026/0158520 A1
(43) Pub. Date: Jun. 11, 2026

(54) LASER ENHANCEMENT OF EDGE COATINGS

(71) Applicant: University of Iowa Research Foundation, Iowa City, IA (US)

(72) Inventors: Hongtao Ding, Coralville, IA (US); Wuji Huang, Iowa City, IA (US); Albert Ratner, Iowa City, IA (US); Mohammad Mohammadzadeh Sanadaji, Iowa City, IA (US)

(21) Appl. No.: 19/362,075

(22) Filed: Oct. 17, 2025

Related U.S. Application Data
(60) Provisional application No. 63/709,251, filed on Oct. 18, 2024.

(51) Int. Cl. B05D 3/06

(52) U.S. Cl. CPC B05D 3/06

(57) ABSTRACT

In coating processes, coating along the edges of a workpiece can be enhanced by pre-treating the edges with a pulsed laser to create surface texture along the edges, optionally in conjunction with chemically treating the edges, e.g., by applying a liquid stabilizing or modifying reagent during laser-texturing. This technique may be applied, for example, to components of battery packs, and may reduce the number of coating passes needed to achieve the desired coating thickness, to a single coating pass in some cases.

### CROSS-REFERENCE TO RELATED APPLICATION

This application claims priority to and the benefit of U.S. Provisional Patent Application No. 63/709,251, filed on Oct. 18, 2024, which is incorporated herein by reference in its entirety.

### BACKGROUND

Many manufacturing processes involve applying a functional coating over the surface of a workpiece to provide, e.g., electrical or thermal insulation, corrosion or wear resistance, low friction, flame retardation, certain optical characteristics, or other desired properties. For instance, within high-voltage battery packs, e.g., as used in electrical vehicles (EVs), battery cells as well as various structural-support and thermal-management components are typically coated with a dielectric material to prevent electrical shorts among batteries and other components, enhance safety of the battery system, and improve performance by preventing leakage currents and energy loss. To achieve the requisite dielectric coating thickness for the desired breakdown voltage, the coating is often applied in multiple cycles of spray coating and ultraviolet (UV) curing, rendering the coating process costly and time-consuming. With the expected rapid growth of the EV battery market, and consequently the battery coating market, over the next decade, there is great interest in more cost-effective coating strategies.

### SUMMARY

Disclosed herein are coating processes that involve pre-treating one or more edges of a workpiece to enhance the adhesion between the coating and the workpiece surface along the edges. This approach leverages the insight that the edges (without such pre-treatment) generally suffer from lower liquid coverage than the faces of the workpiece, and as such often constitute the limiting factor for the coating thickness that can be achieved across the workpiece in a single application cycle, or “coating pass.” Increasing adhesion along the edges, accordingly, can render the coating thickness more uniform between edge(s) and face(s) of the workpiece, and raise the minimum coating thickness over the coated surface portion that results from one coating pass.

In accordance with various embodiments, the workpiece edges are pre-treated by creating a laser-induced surface texture along the edges (or “laser-texturing” the edges), in some cases in conjunction with chemically treating the edges. The surface texture may, for instance, include grooves, or sets of parallel grooves, laser-machined along the edges. Alternatively, overlapping micrometer-scale depressions forming a patterned texture may be created by laser-peening. The laser-induced surface textures increase the overall surface area to which molecules can adhere, and tend to enhance the intrinsic wetting behavior of the surface for the coating, e.g., rendering a hydrophilic surface more hydrophilic and an oleophilic surface more oleophilic. Therefore, for a workpiece surface and coating that are “chemically compatible,” meaning herein that the coating naturally adheres to the surface (e.g., because both are hydrophilic or both are oleophilic), laser-texturing can improve both coating adhesion and coating uniformity.

In some embodiments, laser-texturing is used in conjunction with chemical treatment by application of a chemical reagent to the surface. The chemical reagent may, for instance, be a stabilizing reagent that prevents or mitigates oxidation of the textured surface over time, which might otherwise diminish the benefit of the surface texture. Alternatively, the chemical reagent may be a modifying reagent, that is, a reagent that changes the surface chemistry of the workpiece, e.g., from hydrophilic to oleophilic or vice versa, to allow coating a workpiece with a coating material that is chemically incompatible with the material of the workpiece substrate. In general, if chemical treatment is performed, the chemical reagent may be selected based on the substrate material of the workpiece and/or the coating. In some embodiments, the chemical reagent is sprayed or otherwise applied to the edge simultaneously with the laser-texturing, e.g., using a spray module or other liquid-delivery module mounted to the same positioning device (e.g., multi-axis mount) as the laser head.

Following laser-texturing (and, if applicable, chemical treatment) of the edges, the coating may be applied over all or part of the workpiece, including over the textured edge(s) and, in most cases, the face(s) meeting at those edges. The coating may be applied immediately, e.g., within the same pass in which the laser-texturing is performed, or within a short period of time (e.g., within minutes or hours) of the pre-treatment. Alternatively, a longer period of time may transpire between laser-texturing and coating. In this case, as the textured surface along the edges may be subject to oxidation over time, the laser-textured surface along the edges may be chemically stabilized, using a liquid stabilization reagent sprayed onto or otherwise applied to the edge(s); this may allow the coating step to take place months after the laser treatment.

In some embodiments, laser-texturing (and chemically treating) the edges prior to coating facilitates applying a coating to a minimum thickness of at least 50 μm, or at least 80 μm, or at least 100 μm, in a single pass. Increasing the adhesion for a coating along the edges of a workpiece by laser-texturing the edges (with or without chemical treatment) is a technique herein also referred to as “laser enhancement of edge coatings (LEEC).” Note that laser-texturing in accordance herewith, while in many embodiments selectively applied to the surface region immediately along the edges, is not necessarily limited to the edges in all embodiments, but may extend to the faces of the workpiece as well. However, when texturing the edges suffices to achieve the desired coating thickness over the entire coated region, limiting the laser treatment to the edges provides time and cost savings. Further, in some applications, the coating itself is applied only to the edges, rendering pre-treatment of the faces superfluous.

The disclosed coating process, involving laser-texturing (optionally in conjunction with chemical treatment) of one or more edges followed by application of the desired coating material over at least a portion of the workpiece, can be used for a wide variety of coating and workpiece substrate materials to create coated articles for various industries and applications, including, e.g., battery parts with dielectric coatings. By enhancing coating adhesion, the process can, in some embodiments, achieve desired coating thicknesses with fewer coating passes, providing cost and time savings. Additionally, the disclosed pre-treatment can improve coating performance and durability.

In one aspect, the present disclosure pertains to a method for coating a workpiece. The method includes laser-texturing a surface of the workpiece along one or more edges of the workpiece, and applying a coating over at least the one or more edges of the workpiece, and in some embodiments further over one or more faces of the workpiece meeting at the one or more edges. The coating may be applied over the one or more edges in a single pass with laser-texturing the surface of the workpiece along the one or more edges. Laser-texturing along the one or more edges may comprise laser-machining respective sets of one or more grooves along and parallel to the one or more edges, e.g., spaced at a distance less than the local radius of curvature of the surface at the respective one of the one or more edges. Alternatively, laser-texturing along the one or more edges may comprise laser peening. In some embodiments, the surface of the workpiece and the coating are hydrophilic, and following laser-texturing, the surface of the workpiece along the one or more edges is superhydrophilic (herein understood to mean that the static contact angle is less than 15°). Simultaneously with laser-texturing the surface along the one or more edges, a liquid chemical reagent may be applied to the one or more edges. In one example, the workpiece is made of metal and the chemical reagent is a stabilizing reagent including at least one of nitrile groups, silane groups, phosphate groups, or carboxyl groups. In some embodiment, the coating is a dielectric coating, which may be applied over the one or more edges of the workpiece to a thickness of at least 80 μm in a single pass; the workpiece may be a battery part, such as a battery cell, a cell terminal, a cold plate, a busbar, or a battery pack cover.

In another aspect, the disclosure provides a system for simultaneous laser-texturing and chemical treatment. The system includes a high-power pulsed laser source, a positioning device, a laser head mounted to the positioning device that is configured to receive light from the laser source and emit a focused laser beam, and a liquid-delivery module mounted to the positioning device that is configured to deliver liquid to a target area overlapping with a focus of the laser beam. The system may further include control and processing circuitry configured to control movements of the positioning device relative to the workpiece based on a digital model of the workpiece, and to cause operation of the laser source and the liquid-delivery module so as to cause one or more edges of the workpiece to be simultaneously laser-textured and treated with the liquid.

Yet another aspect concerns a coated article including a volumetric substrate defining a surface that is laser-textured along one or more edges, and a coating adhered to at least a portion of the surface that includes the one or more laser-textured edges. The coating may have a thickness of at least 80 μm over the portion of the surface. Along the one or more edges, the surface of the substrate may be laser-peened, or feature one or more sets of one or more grooves laser-machined into the substrate along and parallel to respective ones of the one or more edges. The coated article may include a metal substrate with a dielectric coating. The article may be a battery part, e.g., a battery cell, a cell terminal, a cold plate, a busbar, or a battery pack cover.

The foregoing summary is provided to introduce a selection of concepts and example embodiments that are further described in the detailed description below. This summary is not intended to identify essential or required features of any claimed subject matter, or to limit the scope of the claimed subject matter in any other way.

### BRIEF DESCRIPTION OF THE DRAWINGS

The foregoing will be more readily understood from the following detailed description, in particular, when taken in conjunction with the accompanying drawings.

FIGS. 1A and 1B are schematic drawings that conceptually illustrate LEEC in accordance with various embodiments.

FIG. 2A is a block diagram of an LEEC system in accordance with various embodiments.

FIG. 2B shows a five-axis laser head mount that may be used in the LEEC system of FIG. 2A, in accordance with various embodiments.

FIG. 2C illustrates a spray gun configured to spray, simultaneously with laser treatment, a liquid reagent at the laser-treated region, in accordance with various embodiments.

FIG. 3A is an image of an example laser-peened aluminum surface in accordance with various embodiments.

FIG. 3B are images of water droplet spreading on the aluminum surface of FIG. 3A before and after laser-peening in accordance with various embodiments.

FIGS. 4A and 4B are schematic drawings, in perspective and cross-sectional views, of an example workpiece having a set of grooves laser-machined along its edge, in accordance with various embodiments.

FIG. 5 is a schematic drawing of an example battery pack.

FIG. 6 is a flowchart of a process for coating a workpiece, in accordance with various embodiments.

### DESCRIPTION

The present disclosure pertains generally to system and methods for manufacturing coated articles. Coatings are widely used across a variety of industries to enhance the performance, durability, and functionality of parts and components. For example, in aerospace and automotive applications, coatings may provide corrosion resistance, thermal insulation, or wear protection under demanding environmental and mechanical conditions. In the electronics and energy sectors, coatings can serve as dielectric layers, conductive films, or protective barriers against moisture and chemical exposure. Medical and consumer products often employ biocompatible or decorative coatings to improve surface properties, cleanliness, and appearance. Depending on the intended function, coatings may be formulated to modify electrical, optical, mechanical, or other characteristics of the underlying substrate, and may be applied using processes such as spraying, vapor deposition, dipping, or curing.

In many circumstances, the performance of a coating for its intended purposes depends on its thickness and/or uniformity across the coated surface. For example, dielectric coatings of many EV battery components are intended to provide electrical isolation for breakdown voltages as high as 2.8-5 kV. For the acrylate-based, UV-curable dielectric formulation Sipiol UV, the coating is applied to a thickness of about 70 μm to achieve such breakdown voltages. Along the edges of a workpiece, however, only about 30 μm coating thickness can be attained with one coating layer. In order to achieve the desired coating thickness of at least 70 μm, therefore, three layers of coating are applied, involving three cycles of spray coating and UV curing, which increases processing time and material cost. The various embodiments disclosed herein address the problem of poor coating along the edges of a workpiece with a technique herein referred to as LEEC. During LEEC, high-energy laser pulses are applied to create surface texture at nanometer or micrometer scale along the edges of the workpiece that promote wetting and adhesion.

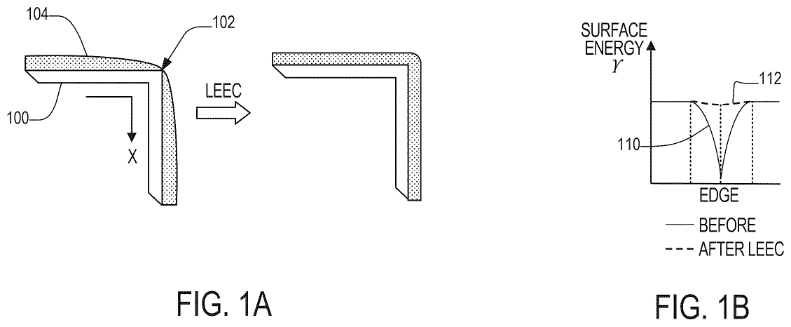

FIGS. 1A and 1B are schematic drawings that conceptually illustrate LEEC in accordance with various embodiments. FIG. 1A shows a portion of a substrate 100 defining two faces that meet at a right angle, forming a sharp edge 102 between them. Without pre-treatment, a chemically compatible liquid applied to the outer, convex surface of the substrate 100 forms a coating 104 over the faces and edge whose thickness decreases towards the edge. For a hydrophilic surface and hydrophilic liquid, the poor edge coverage results from low surface energy along the edge. Generally, for a curved surface, the surface energy increases on a concave surface and decrease on the convex surface, leading to less wetting on the convex edge. On sharp edges (that is, edges with small radius of curvature in a plane transverse to the edge), the wetting is further reduced due to the effects of surface tension and gravity. Laser-texturing of the surface, optionally combined with chemical treatment, has been shown to be able to increase the surface energy and enhance the wetting. Accordingly, with LEEC, as shown on the right in FIG. 1A, more uniform coating coverage across the faces and edge can be achieved. FIG. 1B shows comparative graphs 110, 112 of the surface energy γ of untreated and laser-treated surfaces, respectively, as a function position x along a path across the surface that crosses the edge. For the untreated surface (graph 110), the surface energy features a sharp drop at the edge. With LEEC (graph 112), the surface energy becomes more uniform, decreasing only minimally at the edge.

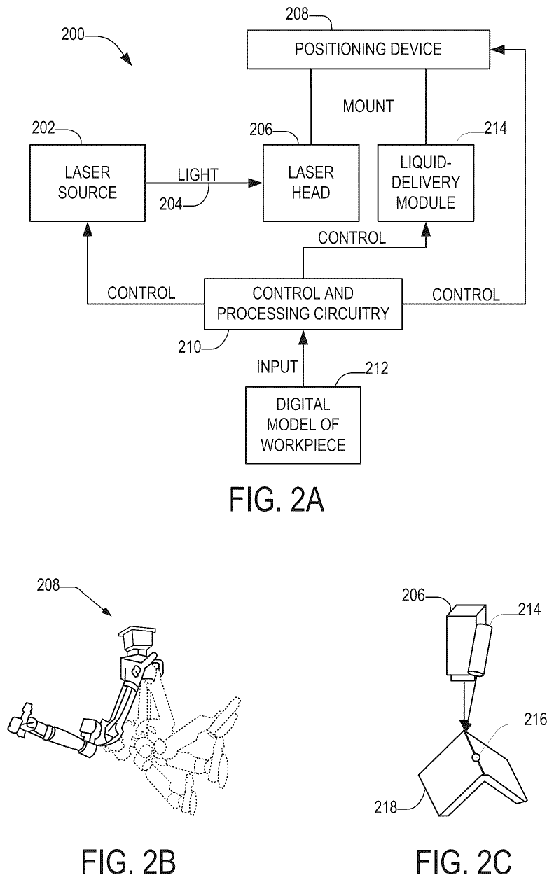

FIG. 2A is a block diagram of an LEEC system 200 in accordance with various embodiments. The system 200 includes a high-power pulsed laser source 202 that generates laser pulses at visible, infrared (IR), or ultraviolet (UV) wavelengths, with sub-microsecond pulse durations and pulse energies ranging from micro-Joules to Joules, depending on the particular application. Suitable lasers commonly used in industrial processing include, for example, Nd:Yag lasers (generating IR light at 1064 nm, or green light at 532 nm after frequency doubling), Yb fiber lasers (generating IR light in the range of 1030-1080 nm), and excimer lasers (generating UV light in the range of 193-308 nm), which generate pulses in the nanosecond or even picosecond range. For even smaller pulse durations, femtosecond lasers, which generate femtosecond to nanosecond pulses at wavelengths between 343 nm and 1064 nm, may also be used. The laser wavelength may be selected based in part on the material of the workpiece substrate, to improve effectiveness of the laser treatment. For example, IR lasers may be used for metals, green and UV lasers for plastics, and UV lasers for semiconductors and ceramics.

Light output by the laser source 202 is directed, e.g., via an optical fiber 204, through a laser head 206, which may include focusing optics and beam-shaping elements, to produce a controlled laser spot at the workpiece surface. The laser head 206 may be mounted to a positioning device 208, such as a multi-axis stage or robotic arm, enabling precise movement of the laser focus across the workpiece in one or more directions. In some embodiments, the positioning device 208 is a five-axis laser-head mount, e.g., as shown in FIG. 2B, which can move the laser head in three translational dimensions and orient it in two rotational dimensions, allowing the laser beam to be accurately positioned and directed onto workpieces with complex geometries. Five-axis laser head mounts are commercially available, and may provide, e.g., 360° rotation and ±135° swing.

Control and processing circuitry 210 controls operation of both the laser source 202 and the positioning device 208 to coordinate the laser pulses with the location of the laser spot on the workpiece. This coordination facilitates processing (e.g., cutting, peening, or otherwise texturing) the workpiece surface selectively, e.g., only along the edges, while maintaining consistent energy delivery and spatial resolution. In some embodiments, the workpiece itself is also mounted on a translation stage or other positioning device, and the control and processing circuitry 210 controls both positioning devices to cause the desired relative movements between the laser head and the workpiece. Control of the relative movements may be based on a digital model 212 of the workpiece, e.g., as provided to the control and processing circuitry 210 in the form of a CAD (computer-aided design) or CAM (computer-aided manufacturing) model. The control and processing circuitry 210 may be implemented by software executed by a general-purpose processor, or by a special-purpose processor (e.g., a digital signal processor (DSP), field-programmable gate array (FPGA), application-specific integrated circuity (ASIC), hardwired electronic circuitry, or any other suitable combination of computing hardware and/or software).

In some embodiments, the system 200 further includes a liquid-delivery module 214, likewise mounted to the positioning device 208 and configured to apply a desired liquid, such as a liquid stabilizing reagent, to the region of the workpiece surface that is treated with the laser, simultaneously with the laser pulse. For instance, as illustrated in FIG. 2C, the liquid-delivery module 214 may be a spray gun, e.g., mounted next to the laser head 206 and directed at the same spot 216 on the edge of the workpiece 218 as the laser light. Operation of the liquid-delivery module 214 may be controlled, and coordinated with the operation of the laser source 202 and the positioning device 208, by the control and processing circuitry 210. Applying a liquid reagent to the surface of the workpiece primarily serves to modify the surface chemistry to preserve or further enhance adhesion of the coating, e.g., to achieve superhydrophilicity of a hydrophilic surface. In addition, the liquid may provide confinement for the laser shots, as well as local cooling of the workpiece to avoid warpage during laser processing.

The system 200 facilitates high-throughput, automated processing of workpieces, rendering it well-suited for large-scale manufacturing. In some embodiments, a production capacity of treating workpiece edges at a speed of more than 1 m/s (e.g., 2 m/s) can be achieved. Further, with a five-axis mount for the laser head, the system allows processing a wide variety of workpieces, including workpieces with complex geometries. Moreover, the system 200 can be configured for different types of surface texturing by selecting appropriate laser parameters (e.g., pulse energy and duration, intensity, repetition rate, overlap of laser spots, etc.)

In various embodiments, laser-texturing the surface along one or more edges involves laser-peening with high-energy, short-duration laser pulses. Suitable pulses may have durations between 5 and 100 ns and pulse energies between 200 mJ and 2 J, distributed over laser spots having diameters between 0.5 and 10 mm and reaching peak intensities in the range from 1 to 10 GW/cm². The pulses may be delivered at a repetition rate between 10 and 200 Hz, and successive pulses may spatially overlap. When impinging on the surface of the workpiece, the pulses each create a shockwave that travels into the workpiece substrate. In some embodiments, a thin confinement layer (e.g., water or glass) is applied on the substrate prior to laser treatment; as the surface layer of the substrate is vaporized when the laser pulse hits, this confinement layer serves to contain the rapidly expanding plasma, maximizing the compressive stresses of the shockwave. A liquid confinement layer (e.g., of water) may be applied simultaneously with a liquid chemical reagent, or a chemical reagent sprayed onto the surface may double as the confinement layer. The shockwave plastically deforms surface layers, leaving shallow depressions (e.g., 1-20 μm deep) and residual compressive stresses that boost adhesion and improve edge strength. For metal substrates (e.g., aluminum, stainless steel, and titanium), residual compressive stresses near the edges may be in the range from 150 to 300 MPa. The shallow depressions generally have a rounded, crater-like shape with smooth edges. Overlap between the depressions due to spatially overlapping laser pulses can create a quasi-periodic surface morphology with a surface roughness, e.g., between 0.5 and 5 μm.

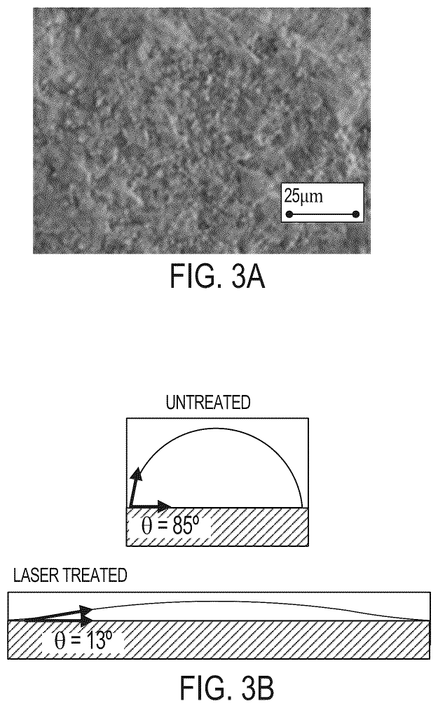

FIG. 3A is an image of an example laser-peened aluminum surface, featuring isotropic, random nanostructures and a surface roughness of less than 1 μm. FIG. 3B compares water droplet spreading on the aluminum surface before and after laser-peening (in this example used in conjunction with chemical treatment to graft water-affinitive nitrile groups onto the laser-textured surface). A contact angle of about 85° before the treatment is reduced, after laser peening and chemical treatment, to a contact angle of about 13°, illustrating superhydrophilic wetting behavior.

In various embodiments, laser-texturing the surface along the edges involves machining grooves along the edges to improve edge wetting as well as mechanical interlock. Suitable pulses may have durations between 10 ps and 200 ns and pulse energies between 20 and 500 μJ), and may be delivered at a high repetition rate, e.g., between 10 and 200 kHz. To create a groove, the laser focus may be moved along the edge at a scan speed of between 200 and 2000 mm/s. In some embodiments, pulse energies between 50 and 500 μJ delivered at a repetition rate between 30 and 200 Hz, combined with a scan speed between 150 and 800 mm/s, result in a fluence of 1-6 J/cm². Grooves may machined to a depth of 5-300 μm (deeper grooves generally being more effective than shallower ones), and may have widths of tens to hundreds of microns (e.g., between in the range from 30-100 μm), depending on the laser spot size. For the deeper grooves within that range, the laser may run along the same line in multiple passes (e.g., two to eight passes). In some embodiments, a single groove is created along the edge. In other embodiments, a set of two or more parallel grooves are machined along the edge, e.g., with a uniform spacing between grooves, or “pitch” (e.g., between 50 and 500 μm). Within sets of multiple grooves, the pitch may be selected based in part on the local radius of curvature, in a plane perpendicular to the edge, of the surface portion that forms the edge. In some embodiments, the grooves are spaced at a distance less than the local radius of curvature. Additionally, the pitch may be adjusted to achieve a desired degree of enhancement of adhesion of the coating. In general, denser spacing of the grooves tends to increase adhesion.

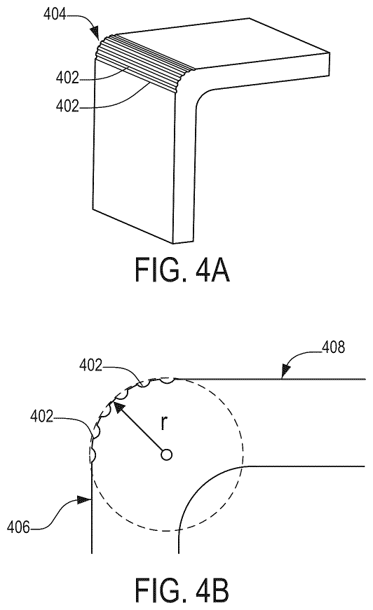

FIGS. 4A and 4B are schematic drawings, in perspective and cross-sectional views, of an example workpiece 400 having a set of grooves 402 laser-machined along its edge 404, in accordance with various embodiments. The edge 404 is formed between two perpendicular faces 406, 408 of the workpiece 400, and is rounded so as to form a quadrantal arc (i.e., an arc spanning 90°, or a quarter of a circle). In this example, six grooves 402 are evenly spaced along the entire quadrantal arc, at a distance of about one third of the radius of curvature (indicated in FIG. 4B) of the surface portion of the workpiece that forms the edge. Other groove numbers and spacings may be used.

In various embodiments, laser-texturing of the edges of a workpiece is accompanied, or immediately followed, by application of a liquid chemical reagent, e.g., a stabilizing reagent that prevents oxidation or other chemical or physical changes of the laser-treated surface, or a modifying reagent that alters the surface chemistry of the substrate, e.g., inverting it from hydrophilic to oleophilic. The reagent may be applied by spraying, which involves propelling fine liquid droplets toward the surface by gas pressure or mechanical force. For example, a solution spray module, such as, e.g., the EXAIR Atomizing Spray Nozzle may be used to deliver the reagent with a maximum pressure of 250 psig at flow rate between 0.8 and 3.2 gph. Alternatively to being sprayed onto the surface, the reagent may be applied by misting (where the surface is exposed to a mist of finer droplets, with gentler or no flow); vapor-phase delivery (where the reagent is transported in vapor or aerosol form to the surface, where it condenses or reacts to form a thin reagent coating); inkjet deposition (where precisely metered droplets of the liquid reagent are selectively placed on the surface by ejection from a digitally controlled nozzle); or ultrasonic atomization (where high-frequency ultrasonic vibration breaks the liquid into micron-scale droplets, which are then directed toward the surface as a fine mist). In some embodiments, the liquid reagent is applied, simultaneously with the laser pulses, to surface regions that include or spatially overlap with the laser spot on the surface; the system 200 of FIG. 2 is suitable for such simultaneous laser and chemical treatment. In other embodiments, the edges are treated with the liquid reagent shortly after laser treatment of the edges is completed.

The choice of chemical reagent generally depends on the materials of the substrate of the workpiece and/or the intended coating. For metal substrates, reagents that include one or more of nitrile groups, silane groups, phosphate groups, or carboxyl groups may be used to increase the hydrophilicity of the surface, e.g., in some cases creating superhydrophilic wetting behavior. An example of such a reagent is 3-cyanopropyltrichlorosilane (CPTCS) [CN(CH₂)₃SiCl₃], which includes water-affinitive nitril groups (—CN). When grafted onto the laser-textured surface of the hydrophilic metal substrate, these (nitril or other) groups increase the surface energy and allow polar molecules (e.g., acrylate) to create temporary hydrogen bonds with the groups and spread into the surface structures, leading to enhanced coating.

The following illustrative, non-limiting examples provide further suitable combinations substrate materials, chemical reagents for application to the laser-textured surface, and coatings: Aluminum 6xxx may be treated with aminosilane (APTES) for enhanced epoxy coating (a dielectric, corrosion-resistant coating). Stainless steel 304 may be treated with organophosphate for polyimide (e.g., Al₂O₃-filled) coatings (a dielectric, thermally insulating coating). Copper 110 may be treated with nitrile-containing primer and coated with silicone HTV (a flexible dielectric). Titanium 6A1-4V may be coated with epoxysilane (GPTMS) for epoxy-ceramic (BN/Al₂O₃) coatings (a dielectric, thermal-cycling coating). In some examples, chemical treatment with a liquid modifying reagent may be used to alter the surface chemistry of the workpiece, e.g., from hydrophilic to hydrophobic or vice versa, to enable a combination of chemically dissimilar substrate and coating. For instance, aluminum 6xxx, which itself is hydrophilic, may be treated with fluorosilane (FAS-17), which is hydrophobic, to enable coating with parylene C (a hydrophobic material used, e.g., as a moisture barrier). Conversely, polyether ether ketone (PEEK), which is naturally hydrophobic, may be treated with plasma-activate acrylic primer to render it hydrophilic and amenable to hydrophilic epoxy coating.

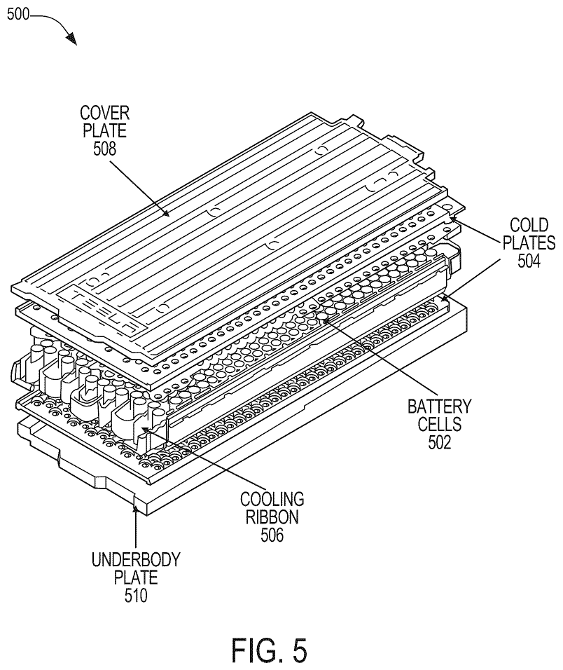

The disclosed processes for enhancing coatings along edges of a workpiece using laser-texturing, optionally in conjunction with chemical treatment, may find application in industrial manufacturing of many parts. In some embodiments, LEEC is applied to components of battery packs, e.g., as used in electric vehicles, drones, or autonomous underwater vehicles. FIG. 5 is a schematic drawing of an example battery pack 500. Battery packs comprise, in addition to battery cells 502, several auxiliary components important for the overall battery performance and safety. Many of these components are electrically insulated to ensure operational reliability and safety. In more detail, battery cells—the fundamental units of the battery pack that store and deliver electrical energy—are insulated at the cell level to prevent electrical shorts and to manage the thermal characteristics of the cells. Busbars and electrical connectors, which facilitate the flow of electrical current between battery cells and to the external circuits, rely on proper insulation to prevent electrical leakage and potential shorts, especially at the connection points where exposure to other conductive elements is likely. The battery management system (BMS), which monitors and manages the performance of the battery pack (e.g., by cell balancing and monitoring the state of charge as well as the temperature), uses insulation to protect the electronic circuits from environmental factors and electrical interference from the high-power components of the battery pack. The thermal management system, which is often integrated with components such as (waveform) cold plates 504, cooling ribbons 506, or cooling fins that are in direct contact with the battery cells, may employ coatings not only for electrical insulation, but also to enhance heat transfer between the cells and the cooling components, and thermal isolation between the cells. Structural components, such as the casing (e.g., the top pack cover, or cover plate, 508 and the bottom pack cover, underbody plate, 510) and frame that hold the battery cells and other components in place, are insulated to prevent conductive paths between the electrically active components and the vehicle chassis or external environment. Some of these components, including the waveform cold plate, top and bottom pack covers, and battery cells include sharp edges and corners with areas particularly susceptible to inconsistencies in coating thickness, which can compromise the insulation integrity. By applying LEEC to these edges, in accordance with various embodiments, overall safety and durability of the battery pack can be improved.

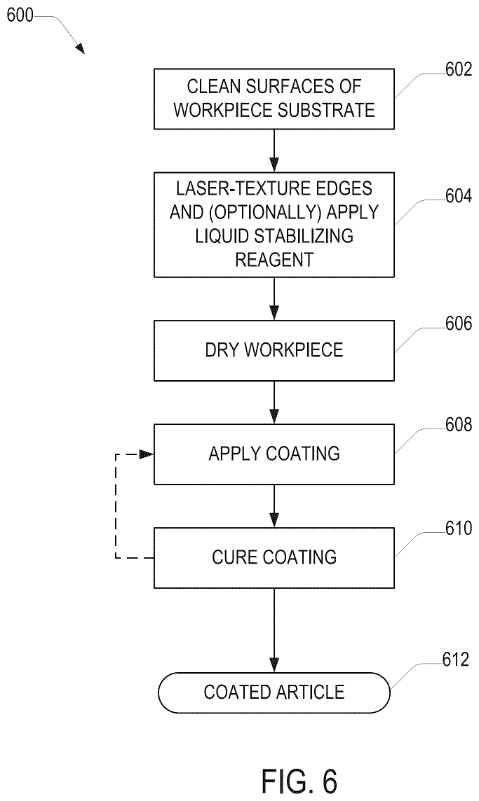

FIG. 6 is a flowchart summarizing a process 600, in accordance with various embodiments, for coating a workpiece, such as, e.g., a battery part. Prior to treatment, the surface of the workpiece may be cleaned (e.g., using a laser etching robotic process), as is common in industrial processing (602). Then, the edges of the workpiece (or, if only a portion of the workpiece surface is to be coated, the edge(s) within that portion) are treated by laser-texturing (604). In many embodiments, a liquid chemical reagent is sprayed onto or otherwise applied to the edges during the laser treatment. For example, aluminum or stainless-steel parts may be sprayed with ethanol solution of 1.5 wt % CPTCS. After such laser-and chemical processing, the workpiece may be dried in air for several minutes (e.g., 10 min) to allow the reagent molecules to settle and graft onto the surface, e.g., to provide a stabilized surface chemistry (606). The workpiece can then be coated, e.g., with a dielectric such as acrylate (like Sipiol UV) or epoxy (608). The coating material can be applied to the workpiece surface in different ways. For instance, it may be sprayed onto the surface, e.g., using a high-volume low-pressure (HVLP) gravity-fed spray gun. The applied coating layer is cured, in some embodiments under UV light (e.g., at ˜1 J/cm²) (610). Multiple layers of coating may be applied and cured in cycles as needed to achieve the desired overall coating thickness. Beneficially, the described pre-treatment of the edges can enhance coating uniformity such that, in some examples, a single coating application suffices to achieve the desired coating thickness for the coated article 612.

Although embodiments have been described with reference to specific example embodiments, it will be evident that various modifications and changes may be made to these embodiments without departing from the broader scope of the invention. Accordingly, the specification and drawings are to be regarded in an illustrative rather than a restrictive sense.

What is claimed is:

1. A method for coating a workpiece, the method comprising:
laser-texturing a surface of the workpiece along one or more edges of the workpiece; and
applying a coating over at least the one or more edges of the workpiece.

2. The method of claim 1, wherein the coating is further applied over one or more faces of the workpiece meeting at the one or more edges.

3. The method of claim 1, further comprising, simultaneously with laser-texturing the surface along the one or more edges, applying a liquid chemical reagent to the one or more edges.

4. The method of claim 3, wherein the workpiece is made of metal and the chemical reagent is a stabilizing reagent comprising at least one of nitrile groups, silane groups, phosphate groups, or carboxyl groups.

5. The method of claim 1, wherein the coating is applied over the one or more edges in a single pass with laser-texturing the surface of the workpiece along the one or more edges.

6. The method of claim 1, wherein laser-texturing along the one or more edges comprises laser peening.

7. The method of claim 1, wherein laser-texturing along the one or more edges comprises laser-machining respective sets of one or more grooves along and parallel to the one or more edges.

8. The method of claim 7, wherein one of the sets comprises multiple grooves spaced at a distance less than a local radius of curvature of the surface at the respective one of the one or more edges.

9. The method of claim 1, wherein the coating is a dielectric coating.

10. The method of claim 9, wherein the coating is applied over the one or more edges of the workpiece to a thickness of at least 80 μm in a single pass.

11. The method of claim 9, wherein the workpiece is a battery part selected from the group consisting of: a battery cell, a cell terminal, a cold plate, a busbar, and a battery pack cover.

12. The method of claim 1, wherein the surface of the workpiece and the coating are hydrophilic, and wherein following laser-texturing, the surface of the workpiece along the one or more edges is superhydrophilic.

13. A system comprising:
a high-power pulsed laser source;
a positioning device;
a laser head mounted to the positioning device and configured to receive light from the laser source and emit a focused laser beam; and
a liquid-delivery module mounted to the positioning device and configured to deliver liquid to a target area overlapping with a focus of the laser beam.

14. The system of claim 13, further comprising:
control and processing circuitry configured to, based on a digital model of a workpiece, control movements of the positioning device relative to the workpiece and to cause operation of the laser source and the liquid-delivery module so as to cause one or more edges of the workpiece to be simultaneously laser-textured and treated with the liquid.

15. A coated article comprising:
a volumetric substrate defining a surface, the surface being laser-textured along one or more edges; and
a coating adhered to at least a portion of the surface that includes the one or more edges along which the surface is laser-textured.

16. The coated article of claim 15, wherein the coating has a thickness of at least 80 μm over the portion of the surface.

17. The coated article of claim 15, wherein the surface is laser-peened along the one or more edges.

18. The coated article of claim 15, wherein the surface features one or more sets of one or more grooves laser-machined into the substrate along and parallel to respective ones of the one or more edges.

19. The coated article of claim 15, wherein the volumetric substrate comprises metal and the coating comprises a dielectric.

20. The coated article of claim 15, wherein the article is a battery part selected from the group consisting of: a battery cell, a cell terminal, a cold plate, a busbar, and a battery pack cover.
